(19) United States
(12) Patent Application Publication
(10) Pub. No.: US 2019/0056261 A1
(43) Pub. Date: Feb. 21, 2019

(54) SYSTEM AND METHOD FOR WEIGHING

(71) Applicant: Martin Wolfgang REGEHR, La Canada, CA (US)

(72) Inventor: Martin Wolfgang REGEHR, La Canada, CA (US)

(21) Appl. No.: 16/104,126

(22) Filed: Aug. 16, 2018

Related U.S. Application Data
(60) Provisional application No. 62/547,060, filed on Aug. 17, 2017.

(51) Int. Cl. G01G 19/02; G01G 19/08; B66C 13/16

(52) U.S. Cl. CPC G01G 19/02; G01G 19/10; B66C 13/16; G01G 19/083

(57) ABSTRACT

A system and method for weighing. A lifting device such as a hydraulic jack is equipped for use with a force or torque measuring device for measuring the input force when an object is lifted. The weight of the object is inferred from the input torque or force required to lift it.

### CROSS-REFERENCE TO RELATED APPLICATION(S)

The present application claims priority to and the benefit of U.S. Provisional Application No. 62/547,060, filed Aug. 17, 2017, entitled “SYSTEM AND METHOD FOR WEIGHING”, the entire content of which is incorporated herein by reference.

### FIELD

One or more aspects of embodiments according to the present invention relate to weighing, and more particularly to a system for weighing employing a lifting device.

### BACKGROUND

In various situations it may be useful to weigh an object that is too heavy to be readily lifted by one person. For example, cargo trailers towed by automobiles or small trucks have weight capacity limits (e.g., limits dictated by the load-carrying abilities of their tires) that may be in the range of a few hundred pounds to a few thousand pounds. When a cargo trailer is loaded, it may be difficult for the user to ascertain whether the load is too heavy for the trailer. Similarly, when hauling dirt or gravel with a small truck, for example, it may be difficult to determine whether the truck is overloaded. A truck scale may be suitable for weighing such a truck or trailer but the use of such a scale, which may be located at some distance from where the truck or trailer is being loaded, may be inconvenient. Portable truck scales used in commercial trucking operations may be too costly for some applications.

Thus, there is a need for a portable, low-cost system and method for weighing.

### SUMMARY

In some embodiments a lifting device, such as a hydraulic jack, is used to measure the force required for lifting. A measuring actuator, such as a torque wrench, is connected to the mechanical input of the lifting device, and the input force or torque required for lifting is measured. The ratio of the input force or torque to the lifting force may be determined by analysis or by measurement, and the lifting force may then be calculated from the ratio and from the measured input force or torque.

### BRIEF DESCRIPTION OF THE DRAWINGS

These and other features and advantages of the present invention will be appreciated and understood with reference to the specification, claims, and appended drawings wherein:

FIG. 1 is an illustration of a related art bottle jack;

FIG. 2A is a perspective view of a bottle jack having a swing socket adapted to be driven by a torque wrench, according to an embodiment of the present invention;

FIG. 2B is side view of a swing socket adapted to be driven by a torque wrench, according to an embodiment of the present invention;

FIG. 2C is side view of a swing socket adapted to be driven by a torque wrench, according to an embodiment of the present invention;

FIG. 3A is an end view of a wrench adapter, according to an embodiment of the present invention;

FIG. 3B is a side view of the wrench adapter of FIG. 3A, according to an embodiment of the present invention;

FIG. 4A is a side view of a ratchet-stop rod, according to an embodiment of the present invention;

FIG. 4B is an end view of a ratchet-stop adapter, according to an embodiment of the present invention;

FIG. 4C is a side view of the ratchet-stop adapter of FIG. 4B, according to an embodiment of the present invention;

FIG. 4D is a side view of the ratchet-stop adapter of FIG. 4B with a torque wrench installed in the ratchet-stop adapter, according to an embodiment of the present invention;

FIG. 4E is an end view of a ratchet-stop adapter, according to an embodiment of the present invention;

FIG. 4F is a side view of the ratchet-stop adapter of FIG. 4E, according to an embodiment of the present invention; and

FIG. 5 is an end view of a trailer showing lifting points, according to an embodiment of the present invention.

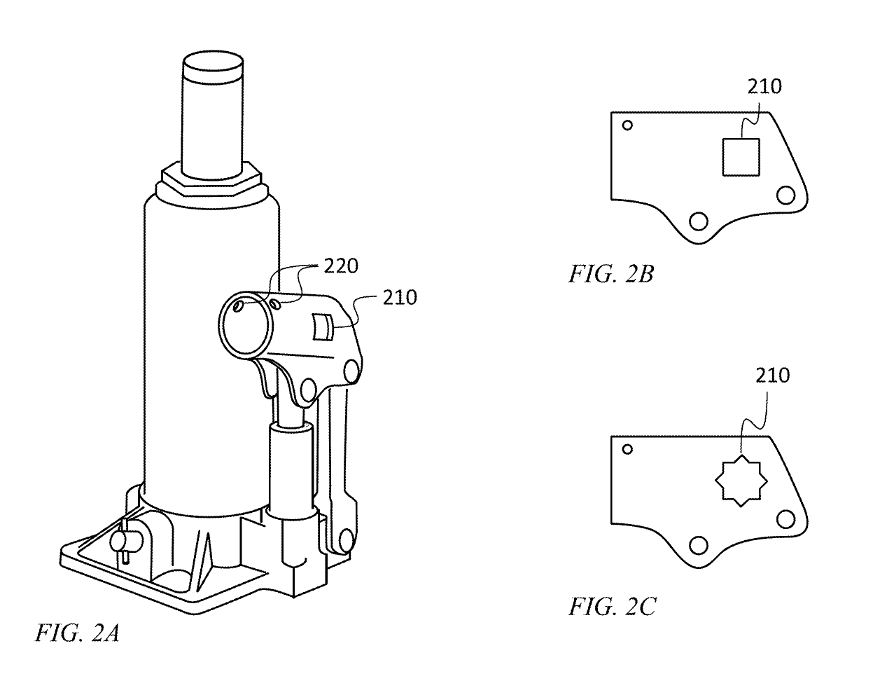

FIGS. 2B-4F are each drawn to scale for a respective embodiment.

### DETAILED DESCRIPTION

The detailed description set forth below in connection with the appended drawings is intended as a description of exemplary embodiments of a system and method for weighing provided in accordance with the present invention and is not intended to represent the only forms in which the present invention may be constructed or utilized. The description sets forth the features of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like elements or features.

In one embodiment, an object to be weighed is supported at three lifting points on three hydraulic jacks. Each of the jacks is then used to further raise the respective lifting point slightly, and, in the process, the portion of the weight of the object borne by the jack, or the “lifting point weight” is measured. The weight of the object is then calculated as the sum of the three lifting point weights. To measure any of the lifting point weights, the force or torque on the handle used to pump the corresponding jack is measured, using one of several systems and methods described in further detail below.

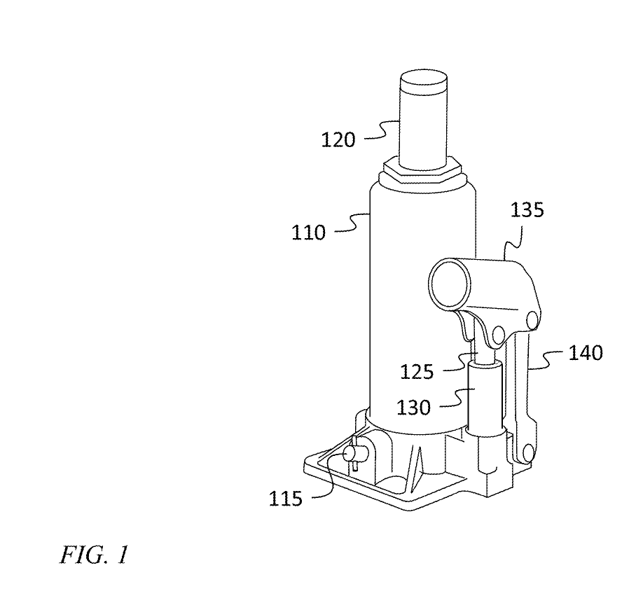

Referring to FIG. 1, a related art manual hydraulic jack also known as a bottle jack includes a hydraulic ram, a pump, a reservoir 110, and a release valve 115. The ram consists of a piston 120 in a cylinder. In operation, hydraulic pressure in the cylinder drives the piston upwards, lifting the load. The top surface of the piston 120, which makes contact with the load, is referred to herein as the “lifting surface”. A seal prevents hydraulic fluid from escaping through the gap between the end of the cylinder and the wall of the piston. The pump includes a smaller diameter piston known as a plunger 125, which reciprocates vertically within a correspondingly smaller diameter cylinder 130. On the upstroke of the plunger hydraulic fluid is drawn from the reservoir into the pump cylinder through a first check valve, and on the downstroke it is pushed through a second check valve into the ram cylinder. Thus repeated cycles of the pump force hydraulic fluid into the ram cylinder, lifting the load. When the release valve is opened it allows fluid to flow directly from the ram cylinder to the reservoir, bypassing the pump, and the load is lowered.

The pump plunger may be caused to reciprocate by inserting a jack handle into a short tube referred to as a swing socket 135 and raising and lowering the jack handle so as to rock the swing socket. A hinge near one end of the swing socket connects it to the upper end of the plunger and a second hinge near the other end of the swing socket connects it to a link plate 140, the other end of which is connected to the jack base 145 via a third hinge. A pair of link plates installed side by side may be used instead of a single link plate 140. The hinges are formed using hinge pins 150, also known as clevis pins or link pins.

The torque applied to the swing socket by the jack handle during a downstroke may be estimated as follows. The pressure of the hydraulic fluid in the ram is approximately equal to the weight W being lifted (i.e., the lifting point weight) divided by the cross-sectional area of the ram piston. As used herein, the “lifting point weight” is the weight borne by the jack, or the vertical force exerted by the jack on the object being lifted. The lifting point weight may be less than the weight of the object being lifted, e.g., if the object is supported at several points, one of which is the jack. The force F on the plunger is approximately equal to the pressure of the hydraulic fluid times the cross-sectional area of the plunger; thus, the force on the plunger is approximately equal to the lifting point weight times the ratio R of the area of the plunger to the area of the ram piston. The torque T on the swing socket is approximately equal to the force on the plunger times the distance D between the two hinges in the swing socket:

T=FD=WRD. (1)

Thus, if the torque is known (e.g., measured during a downstroke), the approximate weight may be calculated from the torque and the characteristics of the jack (e.g., R and D), as follows (by solving Equation (1) for W):

W=T/(RD) (2)

where the lifting point weight W is in units of pounds if the torque T is in units of inch-pounds and the distance D is measured in inches. The ratio of the lifting point weight to the torque (e.g., in this case approximately 1/(RD)) is referred to herein as the “scale factor”. The scale factor may be approximately equal to the ratio of (i) the linear vertical velocity of the lifting surface to (ii) the angular velocity of the swing socket during a downstroke. Equivalently, the scale factor may be approximately equal to the reciprocal of the derivative of the height of the lifting surface with respect to the angle of the swing socket.

A system for measuring the force on the plunger or the corresponding torque can therefore be used to measure the approximate weight of the load being lifted.

In one embodiment, the jack is operated using a torque wrench to apply a torque to the swing socket 135 during a downstroke, and to characterize the torque required to lift the lifting point weight. Such a torque wrench may be one of several varieties, including an indicating variety, and a threshold variety. The indicating variety of torque wrench may have a digital display indicating the torque applied, or it may have an analog display, e.g., a dial or scale and a pointer indicating, on the dial or scale, the currently applied torque. A torque wrench of the threshold variety may be a “clicking”, “click-stop” or “click-type” variety, or a limiting variety. A click-type torque wrench may have an adjustable torque setting and it may click when the applied torque is increased past this setting. A limiting torque wrench may have a clutch that slips when the torque reaches a threshold torque, preventing the applied torque from exceeding the threshold.

If the plunger bottoms out (i.e., reaches the end of its travel), then while it is bottomed out the torque applied to the swing socket may exceed the torque applied just before the plunger bottomed out, and may not provide an accurate indication of the lifting point weight. In this case one or more additional downstrokes may be performed until a torque measurement or characterization is completed without the plunger bottoming out.

As used herein, a “torque wrench” is any tool (or combination of tools) that may be used to apply a torque and to characterize the applied torque. As used herein “characterizing” the applied torque includes measuring the applied torque or determining (as in the case of a clicking torque wrench or a limiting torque wrench) whether it exceeds a set threshold.

Indicating Wrench

As mentioned above, an indicating torque wrench may be used to measure the torque during a downstroke. One kind of indicating torque wrench, which may be referred to as a “beam” torque wrench, includes a first beam through which torque is applied, and a second, substantially parallel beam that indicates, at a scale near the handle end of the torque wrench, the amount by which the first beam is deflected as a result of torque being applied through it.

In one embodiment, a torque wrench is constructed by connecting a torque adapter of the kind described, for example, in U.S. Patent Application No. 2011/0120233, to the drive nub end of a drive handle (e.g., a ratchet handle, a breaker bar, or the like). A torque adapter (or “digital torque adapter” or “torque measurement adapter”) is a measuring instrument that has a first connector (e.g., a square ½″ drive socket or a square ⅜″ drive socket) and a second connector (e.g., a square ½″ drive nub or a square ⅜″ drive nub), coaxial with the first connector. The torque adapter measures the torque it transmits (from the first connector to the second connector), and displays it, e.g., on a digital display that is part of the torque adapter. The torque adapter may include the ability to record the maximum torque measured. In some embodiments such a torque adapter is connected in series between a drive handle the operator uses to actuate the jack, and the swing socket. The operator then executes a downstroke, without bottoming out the plunger, and multiplies the torque reading (e.g., the maximum torque reading observed during the downstroke, or the maximum torque recorded by the torque adapter) by the scale factor for the weighing system to obtain the lifting point weight. In some embodiments a measuring adapter (e.g., such as that disclosed in U.S. Pat. No. 2,877,645) is instead connected to the handle end of a drive handle, to similar effect.

Threshold Wrench

Another variety of torque wrench, referred to herein as a “threshold torque wrench” may be used to determine whether or not an applied torque exceeds a set threshold. One example of a threshold torque wrench is a click-type, or “click stop”, or “clicking” torque wrench, that clicks when the torque exceeds a set threshold value (that may be fixed or user-adjustable). With a threshold torque wrench it may only be possible to determine whether the torque during a downstroke (or the lifting point weight) exceeds a threshold value (i.e., the setting of the torque wrench, or the corresponding weight). If the setting of the threshold torque wrench is adjustable, however, it may be possible to measure the lifting point weight using a method of successive approximation, e.g., increasing the torque setting if the wrench clicks on a given downstroke, or decreasing it if it does not click, until the upper bound and lower bound (on the torque, and on the corresponding weight) established in this manner are sufficiently close together to provide a measurement having acceptable precision.

A limiting torque wrench may be constructed by connecting a torque adapter of the kind disclosed, for example, in U.S. Pat. No. 3,889,490, to the drive nub end of a drive handle. When a limiting torque wrench is used, the clutch of the wrench will slip (resulting in motion of the wrench handle without motion of the swing socket and without raising of the load) if the lifting point weight exceeds the weight corresponding to the torque setting of the wrench.

Wrench/Jack Interface

Various systems may be used to connect the torque wrench to the swing socket. A commercially available torque wrench may be a square drive wrench, e.g., a “¼ inch drive” wrench “⅜ inch drive” wrench, “½ inch drive” wrench or the like, having a square drive nub of corresponding size, also known as a square stud or square extension, designed to be coupled to a driven part, such as a socket, which has a square recess for receiving the drive nub.

Referring to FIG. 2A, in one embodiment, a hydraulic jack may be fitted with a swing socket 205 having a square transverse hole 210 for receiving the drive nub of a torque wrench. This hole may be square, as illustrated in FIGS. 2A and 2B, or it may have any other shape suitable for receiving the drive nub of a torque wrench, including an eight-pointed star (as shown in FIG. 2C) corresponding to two square holes, one rotated 45 degrees relative to the other, or a twelve-pointed star corresponding to three square holes, each rotated 30 degrees relative to the other two. A hole in the shape of a star may facilitate the alignment of the torque wrench nub with the hole during assembly, and, for a non-ratcheting wrench may make it possible for the wrench handle to be more nearly aligned with the swing socket than if the transverse hole is square.

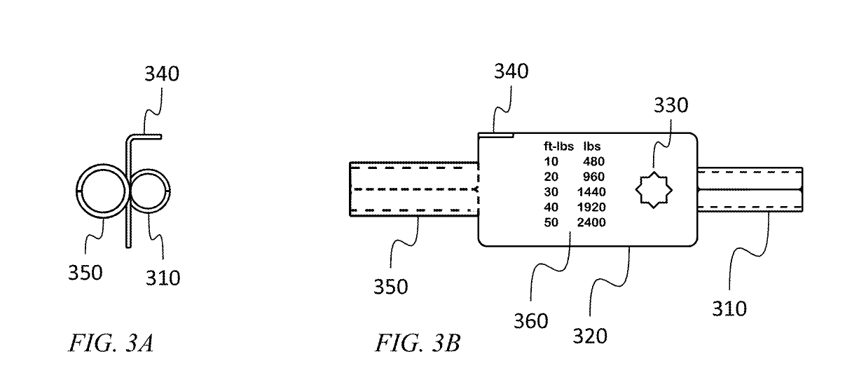

Referring to FIGS. 3A and 3B, in another embodiment, a wrench adapter may be used for coupling a torque wrench to the swing socket. Such an adapter may have a first cylindrical or tubular portion 310 that fits into the swing socket, and a plate portion 320 which has a square or star shaped hole 330, for receiving a square cross section drive nub. Such an adapter may be made, for example, of sheet metal or of reinforced plastic. The entire adapter may be formed from a single piece of sheet metal using suitable cutting and bending operations.

If the centerline of the torque wrench handle is offset horizontally from the centerline of the swing socket, then downwards force applied to the torque wrench handle by the operator may result in a tendency of the adapter to twist in the swing socket. To reduce this effect, it may be preferable to construct the adapter so that a torque wrench of typical dimensions will be located, when coupled to the adapter, with the centerline of its handle close to that of the adapter tube. In the embodiment of FIGS. 3A and 3B, for example, inserting the torque wrench from the side of the plate portion 320 on which the centerline of the swing socket passes (instead of from the other side of the plate portion 320), may reduce the tendency to twist. A handle with a cross-beam (at the end grasped by the operator) may also be used to mitigate the tendency to twist. For example, a tee handle breaker bar or flex handle e.g., Craftsman model 44202, may be used. The cross-bar on such a wrench may allow the operator to prevent the handle from twisting as a downwards force is applied.

In other embodiments a wrench adapter may be fabricated to be clamped to the swing socket or to the jack handle, near the swing socket. Various clamp styles may be used, e.g., a collar with a set screw, a tightening clamp (with, e.g., the tightening mechanism of a hose clamp), a clamshell clamp, and the like. A part having a square recess (or a recess in the shape of an 8-pointed star or 12-pointed star) may be secured to the clamp (or the clamp itself may have such a recess) and provide a socket for the nub of a torque wrench.

Ratcheting Wrench

Some torque wrenches include an integrated ratchet mechanism. If such a wrench is used, and if the direction of the ratchet is set so as to engage during the downstroke, the ratchet may slip when the wrench handle is lifted, and as a result lifting the wrench handle may fail to lift the plunger. To avoid this problem the operator may move her or his hand from the end of the wrench handle to the swing socket during the upstroke to apply an upward force directly to the swing socket.

In another approach, in the embodiment of FIGS. 2A-2C, if the square drive nub of the torque wrench does not extend sufficiently far into the swing socket 135 to interfere with insertion of the jack handle (or, e.g., if a sufficiently small-diameter tube is used as a jack handle, or if the jack handle is inserted only part-way into the swing socket 135) the jack handle may be used to execute the upstrokes, or the upstrokes and the downstrokes until the jack bears the full weight at the lifting point; the torque wrench may then be used to perform one or more downstrokes and to measure the torque during these downstrokes.

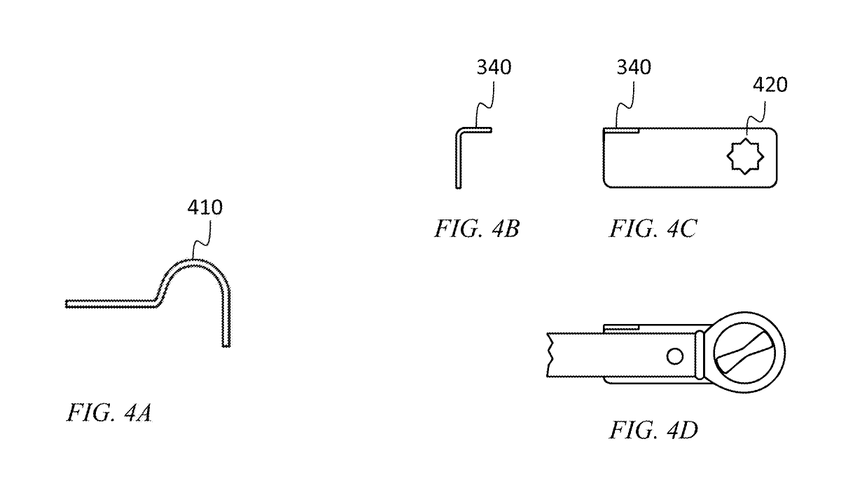

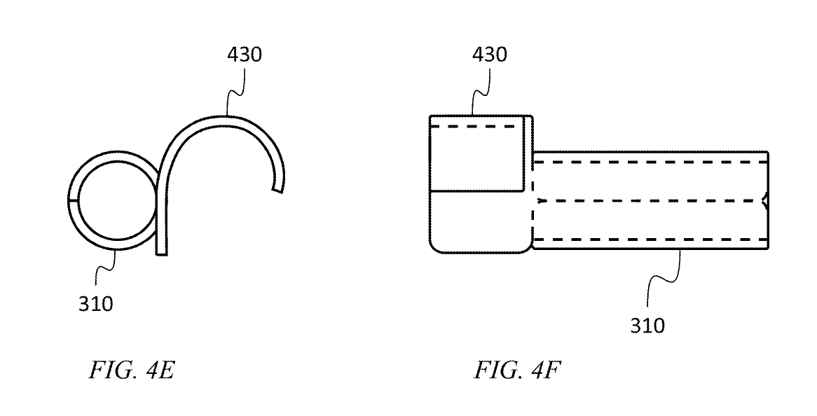

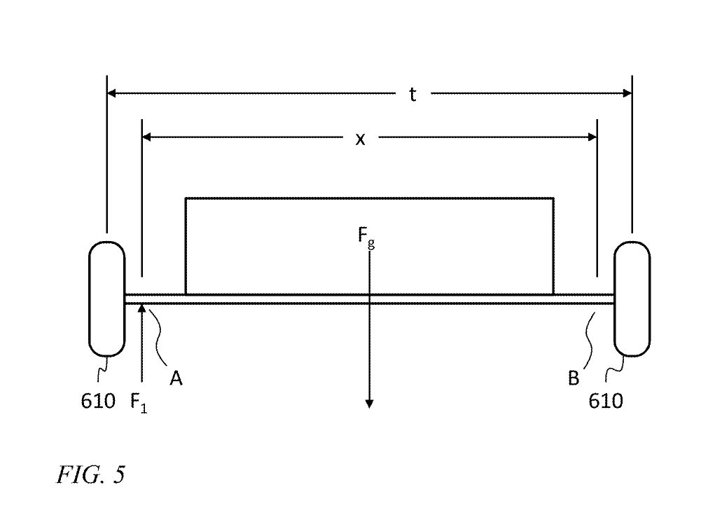

Referring again to FIGS. 3A and 3B, a wrench adapter may also be equipped with a ratchet-stop tab 340, which may extend over the top of the torque wrench handle when the torque wrench is coupled to the adapter, preventing the ratchet from slipping past the point at which the torque wrench handle contacts the ratchet stop tab. Referring to FIG. 4A, in other embodiments a ratchet-stop rod 410 may be inserted through ratchet-stop rod holes 220 (FIG. 2) in the swing socket 135, and the torque wrench handle may contact the ratchet-stop rod 410 during the upstroke, preventing the ratchet from slipping further. The rod may be bent (e.g., as shown in FIG. 4A) to prevent it from moving too far into or out of the ratchet-stop rod holes 220 during use. Any other method of connecting the torque wrench handle to the swing socket may be used, provided it is sufficiently sturdy to exert the torque required to execute an upstroke of the plunger.

Referring to FIGS. 4B-4D, in one embodiment a ratchet-stop adapter may be a plate with a square or star-shaped hole 420 and with a ratchet-stop tab 340. The ratchet-stop adapter may fit onto the nub of a ratcheting torque wrench to prevent the ratchet from slipping during the upstroke. The plate may be sufficiently thin to allow the portion of the nub protruding through the hole 420 to be sufficiently long to engage, e.g., a hole 210 in the swing socket or a hole 330 in a wrench adapter.

Referring to FIGS. 4E and 4F, in one embodiment a ratchet-stop adapter includes a cylindrical or tubular portion 310 that fits into the swing socket, and a curved ratchet-stop tab 430 that, in use, wraps around the top of the wrench handle.

Referring again to FIGS. 3A and 3B, in one embodiment, a wrench adapter includes a second tubular portion 350 with an inside diameter that accommodates the jack handle. In this embodiment the jack handle may be inserted into the wrench adapter and used for upstrokes and downstrokes until the jack bears the full weight at the lifting point; the torque wrench may then be used to perform one or more downstrokes and to measure the torque during these downstrokes.

Method for Measuring the Lifting Point Weights

In one embodiment, a torque wrench is mechanically connected to the swing socket 135 of a jack, and the jack pump is operated until the weight at the lifting point is borne by the jack. The torque is then measured during a downstroke, and the lifting point weight is inferred from the measured torque.

For example, if the plunger has a diameter of 0.500″, and the ram piston has a diameter of 1.000″, then the area ratio (the ratio of the plunger area to the area of the ram piston, or π(0.500)²/π(0.500)²)) is ¼. If the distance between the two hinges in the swing socket is 1″ and the measured torque is 250 inch-pounds, then the weight borne by the jack is, from Equation (2) above, 250 inch pounds/(1 inch×¼)=1000 pounds.

If a threshold torque wrench is used, it may be set, for example, to a torque setting corresponding to the maximum acceptable lifting point weight. If a trailer has wheels with a load capacity of 1000 pounds each, for example, and the jack is placed to as to lift the weight borne, in operation, by one wheel (or, as discussed in further detail below, the jack is placed so as to lift slightly more than the weight borne by one wheel), then the torque wrench may be set, for example, to 20 foot-pounds (240 inch-pounds), so that if it does not click during the downstroke, the weight is less than that corresponding to 20 foot-pounds (240 inch-pounds). For the jack described above, this weight is approximately 960 pounds. In this circumstance, if the wheel is jacked clear of the ground and the torque wrench does not click, the wheel is not overloaded. The other wheel may be checked separately, in case the load is not centered. If the torque wrench clicks, the trailer is either overloaded, or loaded to very near capacity. Similarly, if a limiting torque wrench is used with a setting corresponding to the maximum acceptable weight, then if the jack is able to lift the weight without the wrench slipping, the weight is acceptable.

With a threshold torque wrench, the weight may, as mentioned above, be bracketed between increasingly narrow bounds by adjusting the setting after each downstroke. For example, if the wrench clicks at 15 foot-pounds the setting may be increased to 25 foot-pounds, and, if it does not click at 25 foot pounds it may be decreased to 20 pounds. The upper and lower bounds may be brought closer together in this manner, until the torque is bounded between two torque values that are sufficiently close together to reduce the uncertainty in the torque to an acceptable level.

The calculation of the lifting point weight may be performed using any of several methods. A calculator or computer (or other computing device, such as a suitable mobile phone) may be used. In other embodiments, one or more tables may be used. Such a table may have one column listing various values of torque and a second column listing the corresponding lifting point weight. For example, for the exemplary jack described above, the first column may show torque in foot-pounds, in increments of one foot-pound, and the second column may show a weight (in pounds) that for each row is equal to 48 times the torque (in foot-pounds). A small table 360 (FIG. 3B) (e.g., a table with relatively coarse torque increments) may be marked on (e.g., stamped into) a wrench adapter, insuring that the table is available when the adapter is used.

Wheel Loading of a Single-Axle Trailer

Referring to FIG. 5, in one embodiment, the wheel loading of a single-axle trailer may be measured as follows. The jack may be placed under one end of the axle, as near as possible to one wheel 610 (e.g., at point A), and the lifting point weight measured. The jack may then be placed under the other end of the axle (e.g., at point B) and the lifting point weight measured. The two lifting point weights measured in this manner may be added to form a measurement of the total wheel loading.

The weight obtained in this manner may be an overestimate because the lifting point may be nearer the center of the trailer than the wheel, so that when the jack raises one side of the axle, the jack bears more weight than the wheel supported, before it was raised. This weighing error may be reduced in some cases by placing the jack as near as possible to the wheel. In some cases a correction may be made. For example, if the load is centered, and has a weight F_{g}, and if the positions of the two lifting points, at A and B, are symmetric about the center, then when one side of the trailer is lifted, with a force F₁, the following is approximately true (so that the total moment about the contact patch of the second tire vanishes): F₁ [x+(t−x)/2]=F_{g} t/2, where x is the distance between the two lifting points and t is the track of the trailer, i.e., the distance between the two contact patches at which the two tires contact the ground. This equation may be rearranged to yield F_{g}=(x+t)/t F₁. Accordingly, to find the total wheel loading, the one-sided lifting point weight F1 may be multiplied by (x+t)/t, or the total lifting point weight F₁+F₂ may be multiplied by (x+t)/(2 t).

In one embodiment two jacks are used at the respective lifting points (e.g., two jacks both equipped to be operated by torque wrenches, or two jacks, one of which is so equipped, that are interchanged to perform the second lifting point weight measurement) so that the total weight borne by the two jacks when both wheels are lifted off the ground is substantially equal to the weight borne by both wheels when the jacks are removed. This method may also reduce errors that otherwise may be introduced as a result of the trailer being tilted to one side when the lifting point weight is measured.

The weight obtained by these method may be the total weight borne by the wheels (i.e., it may exclude the tongue weight) and as such it may be a relevant measurement for determining whether the tires are overloaded. If it is desired to measure the tongue weight as well (e.g., to measure the total weight of the trailer, or to determine whether the fore-aft position of the load is correct) the tongue may be lifted and weighed separately (i.e., a lifting point weight measurement may be made with the jack lifting only the tongue).

Three jacks may be used to weigh the trailer (or another vehicle), by lifting the vehicle clear of the ground. Three jacks equipped with embodiments of the invention described herein may be employed, and the totals of the weights measured at the three lifting points may be used as an estimate of the total trailer weight. Alternatively, two ordinary jacks and one jack equipped with an embodiment of the invention described herein may be used, by rotating the jack so equipped to each of the three lifting points in turn. In another embodiment two or three jack stands are used to support the trailer (or the frame at the wheels, leaving the tongue otherwise supported) and the weight is taken off of one jack stand at a time by a jack, equipped with an embodiment of the present invention, adjacent to the jack stand.

To measure the rear-wheel loading of a truck (e.g., a pickup truck or other truck having a single rear axle), it may be helpful to support the front of the truck on a single jack stand, to avoid weight redistribution between the two front wheels when one rear wheel is lifted from affecting the weight measurement.

Other Considerations

For various reasons, in some embodiments, the relationship between input torque or force and the lifting point weight may differ from that of Equation (2). For example, the linkage connecting the swing socket 135 to the plunger 125 may cause the scale factor to vary as the plunger moves. A lifting device other than a bottle jack, such as a hydraulic floor jack or trolley jack, which may be used like a bottle jack (with a torque wrench coupled to a swing socket of the jack, e.g., through an adapter for accepting a torque wrench drive nub clamped to (or around) the swing socket, or the handle near the swing socket) may have a linkage between the ram and the lifting surface, or a return spring connected to the plunger, or the weight of the jack handle may exert a significant torque on the swing socket, any of which may affect the torque requirement for a given lifting point weight. Such effects may cause the scale factor to vary with ram position or plunger position. In some embodiments, if the axis of the torque wrench is offset from the pivot point of the swing socket (e.g., if the wrench adapter of FIGS. 3A and 3B is used), the torque on the swing socket may differ from the indication of the torque wrench, and it may depend on the angle between the torque wrench and the swing socket. In some cases, (as, for example, if the weight of the jack handle or the force of a return spring are significant), the lifting point weight may at any instant be approximately equal to the scale factor times the torque plus (or minus) an offset. In some embodiments, for example, the following equation may be used, instead of equation (2), to estimate the lifting point weight:

W=S(hₚ, hᵣ)T+O(hₚ, hᵣ) (3)

where hₚ and hᵣ are the position (e.g., the height) of the plunger and the ram respectively, S(hₚ, hᵣ) is the scale factor (as a function of hₚ and hᵣ) and O(hₚ, hᵣ) is the offset (as a function of hₚ and hᵣ). In some embodiments the variation with plunger position is ignored and/or the offset is ignored, so that the lifting point weight is calculated instead, for example, as W=S(hᵣ)T+O(hᵣ) or as W=S(hᵣ)T.

In some embodiments an analysis (e.g., a numerical analysis) may be used to calculate the torque required as a function of the lifting point weight and of any other parameters on which the torque may depend. In other embodiments the scale factor may be measured, e.g., by lifting a known weight and measuring the torque required at various points in a downstroke and at various heights of the lifting point. A function (e.g., a polynomial, or a piecewise polynomial spline) may then be used to fit the results, and this function may subsequently be used to estimate the lifting point weight when the torque and other parameters (e.g., the height of the lifting surface) are known. In some embodiments the function is implemented as a look-up table, or as a look-up table with interpolation.

It may be difficult for an operator to note the torque and the position of the jack handle simultaneously, so that correcting for variation as a function of jack handle position may be challenging. Nonetheless, information regarding the extent to which the scale factor or offset varies with jack handle position may be used for determining whether measurements should only be made over a narrow range of jack handle positions (e.g., near the end of a downstroke) or for estimating the uncertainty in a lifting point weight measurement.

In some embodiments a piece of software is provided to the operator, who may enter the torque measured, and, e.g., the degree of extension of the jack (e.g., measured in inches). The software may then calculate and display the lifting point weight. Such software may execute on a mobile device (e.g., a smart phone). In some embodiments the torque measuring device (e.g., a related art torque measurement adapter, enhanced to have wireless capabilities) transmits the torque directly to a smart phone via a wireless connection, and the smart phone displays the lifting point weight (or the entire weight of the object after two or three lifting point weights have been measured). In some embodiments the software adjusts the estimated weight to account for such effects as pressure drop across the second check valve, friction in the hydraulic seals, or the weight of the jack handle.

In some embodiments a non-hydraulic jack (e.g., a scissor jack having a transverse jack screw) may be used to measure a lifting point weight by measuring (e.g., with a torque wrench or other torque measuring device) the torque required to lift the load incrementally. In some embodiments the input force or torque required to operate a lifting device and to lift a load is measured without using a square drive torque wrench but using another measuring device instead. For example, the handle or swing socket of a hydraulic jack (or the handle of another kind of jack) may include a device for measuring the force or torque applied to the handle or to an input element of the lifting device (e.g., the jack screw of a scissor jack). Any system for measuring the bending moment to which the jack handle is subjected, or the resulting deformation (e.g., bending) of the jack handle (such as one or more strain gauges secured to a jack handle) may be used to measure the torque on the swing socket or the force on the plunger during a downstroke. The force applied to the jack handle during a downstroke may be measured, e.g., with a load cell or spring balance. In a hydraulic jack in which the force on the plunger is applied during a downstroke by a link or other element exerting a compressive force on the upper surface of the plunger, a load cell may be inserted on top of the plunger to measure the compressive force.

Although exemplary embodiments of a system and method for weighing have been specifically described and illustrated herein, many modifications and variations will be apparent to those skilled in the art. Accordingly, it is to be understood that a system and method for weighing constructed according to principles of this invention may be embodied other than as specifically described herein.

What is claimed is:

1. A system for weighing comprising:
a lifting device having a mechanical input and a mechanical output for lifting, the lifting device providing a mechanical advantage; and
a measuring device for measuring a force or torque applied to the mechanical input during a lifting operation.

2. The system of claim 1, wherein the lifting device is a hydraulic jack.

3. The system of claim 2, wherein the lifting device is a bottle jack.

4. The system of claim 3, wherein the measuring device is a torque wrench.

5. The system of claim 4, wherein the bottle jack has a swing socked configured to be coupled to the torque wrench.

6. The system of claim 4, further comprising an adapter configured to couple the torque wrench to the swing socket.

7. An adapter, having:
a first portion configured to be coupled to a swing socket of a hydraulic jack, and
a second portion, configured to be coupled to a torque wrench.

8. The adapter of claim 7, wherein the first portion is an elongated member fitting inside the swing socket.

9. The adapter of claim 8, wherein the first portion is a tubular member.

10. The adapter of claim 7, wherein the second portion is a hole.

11. The adapter of claim 10, wherein the hole is square.

12. The adapter of claim 10, wherein the hole is star-shaped.
